(19) United States
(12) Patent Application Publication
(10) Pub. No.: US 2002/0093954 A1
(43) Pub. Date: Jul. 18, 2002

(54) Failure protection in a communications network

(76) Inventors: Jon Weil, Coton (GB); Elwyn Davies, Ely (GB); Loa Andersson, Alvsjo (SE); Fiffi Hellstrand, Stockholm (SE)

Correspondence Address: William M. Lee, Jr., Lee, Mann, Smith et al., PO Box 2786, Chicago, IL, 60690-2786, US

(21) Appl. No.: 09/897,001

(22) Filed: Jul. 2, 2001

Related U.S. Application Data
(60) Provisional application No. 60/258,405, filed on Dec. 27, 2000.
(60) Provisional application No. 60/216,048, filed on Jul. 5, 2000.

(51) Int. Cl. H04L 12/28

(52) U.S. Cl. 370/389; 370/238

(57) ABSTRACT

A communications packet network comprises a plurality of nodes interconnected by communication links and in which tunnels are defined for the transport of high quality of service traffic. The network has a set of primary traffic paths for carrying traffic and a set of pre-positioned recovery (protection) traffic paths for carrying traffic in the event of a fault affecting one or more the primary paths. The network incorporates a fault recovery mechanism. In the event of a fault, traffic is switched temporarily to a recovery path. The network then determines a new set of primary and recovery paths taking account of the fault. The traffic is then switched to the new primary paths. The new recovery paths provide protection paths in the event of a further fault. The network nodes at the two ends of a recovery path exchange information over that path so that packets returning to the main path present labels that are recognizable for further routing of those packets.

### RELATED APPLICATIONS

Reference is here directed to our co-pending application Ser. No. 60/216,048 filed on Jul. 5, 2000, which relates to a method of retaining traffic under network, node and link failure in MPLS enabled IP routed networks, and the contents of which are hereby incorporated by reference.

### FIELD OF THE INVENTION

This invention relates to arrangements and methods for failure protection in communications networks carrying packet traffic.

### BACKGROUND OF THE INVENTION

Much of the world's data traffic is transported over the Internet in the form of variable length packets. The Internet comprises a network of routers that are interconnected by communications links. Each router in an IP (Internet Protocol) network has a database that is developed by the router to build up a picture of the network surrounding that router. This database or routing table is then used by the router to direct arriving packets to appropriate adjacent routers.

In the event of a failure, e.g. the loss of an interconnecting link or a malfunction of a router, the remaining functional routers in the network recover from the fault by re-building their routing tables to establish alternative routes avoiding the faults. Although this recovery process may take some time, it is not a significant problem for data traffic, typically ‘best efforts’ traffic, where the delay or loss of packets may be remedied by resending those packets. When the first router networks were implemented link stability was a major issue. The high bit error rates, that could occur on the long distance serial links which were used, was a serious source of link instability. TCP (Transmission Control Protocol) was developed to overcome this, creating an end to end transport control.

In an effort to reduce costs and to provide multimedia services to customers, a number of workers have been investigating the use of the Internet to carry delay critical services, particularly voice and video. These services have high quality of service (QoS) requirements, i.e. any loss or delay of the transported information causes an unacceptable degradation of the service that is being provided.

A particularly effective approach to the problem of transporting delay critical traffic, such as voice traffic, has been the introduction of label switching techniques. In a label switched network, a pattern of tunnels is defined in the network. Information packets carrying the high quality of service traffic are each provided with a label stack that is determined at the network edge and which defines a path for the packet within the tunnel network. This technique removes much of the decision making from the core routers handling the packets and effectively provides the establishment of virtual connections over what is essentially a connectionless network.

The introduction of label switching techniques has however been constrained by the problem of providing a mechanism for recovery from failure within the network. To detect link failures in a packet network, a protocol that requires the sending of KeepAlive messages has been proposed for the network layer. In a network using this protocol, routers send KeepAlive messages at regular intervals over each interface to which a router peer is connected. If a certain number of these messages are not received, the router peer assumes that either the link or the router sending the KeepAlive messages has failed. Typically the interval between two KeepAlive messages is 10 seconds and the RouterDeadInterval is three times the KeepAlive interval.

In the event of a link or node failure, a packet arriving at a router may incorporate a label corresponding to a tunnel defined over a particular link and/or node that as a result of the fault, has become unavailable. A router adjacent the fault may thus receive packets, which it is unable to forward. Also, where a packet has been routed away from its designated path around a fault, it may return to its designated path with a label at the head of its label stack that is not recognised by the next router in the path. Recovery from a failure of this nature using conventional OSPF (open shortest path first) techniques involves a delay, typically 30 to 40 seconds which is wholly incompatible with the quality of service guarantee which a network operation must provide for voice traffic and for other delay-critical services. Techniques are available for reducing this delay to a few seconds, but this is still too long for the transport of voice services.

The combination of the use of TCP and KeepAlive/RouterDeadInterval has made it possible to provide communication over comparatively poor links and at the same time overcome the route flapping problem where routers are continually recalculating their forwarding tables. Although the quality of link layers has improved and the speed of links has increased, the time taken from the occurrence of a fault, its detection, and the subsequent recalculation of routing tables is significant. During this ‘recovery’ time it may not be possible to maintain quality of service guarantees for high priority traffic, e.g. voice. This is a particular problem in a label switched network where routing decisions are made at the network edge and in which a significant volume of information must be processed in order to define a new routing plan following the discovery of a fault.

A further problem is that of maintaining routing information for packets that have been diverted along a recovery path. In a label switched network, each packet is provided with a label stack providing information on the tunnels that have been selected at the network edge for that packet. When a packet arrives at a node, the label at the top of the stack is read, and is then “popped” so that the next label in the series comes to the top of the stack to be read by the next node. If, however, a packet has been diverted on to a recovery path so as to avoid a fault in the main path, the node at which the packet returns to the main path may be presented with a label that is not recognised by that particular node. In this event, the packet may either be discarded or returned. Such a scenario is unacceptable for high quality of service traffic such as voice traffic.

### SUMMARY OF THE INVENTION

An object of the invention is to minimise or to overcome the above disadvantage.

A further object of the invention is to provide an improved apparatus and method for fault recovery in a packet network.

According to a first aspect of the invention, there is provided a method of controlling re-routing of packet traffic from a main path to a recovery path in a label switched packet communications network in which each packet is provided with a label stack containing routing information for a series of network nodes traversed by the packet, the method comprising; signalling over the recovery path control information whereby the label stack of each packet traversing the recovery path is so configured that, on return of the packet from the recovery path to the main path, the packet has at the head of its label stack a recognisable label for further routing of the packet.

According to a further aspect of the invention, there is provided a method of controlling re-routing of packet traffic in a label switched packet communications network at a first node from a main path to a recovery path and at a second node from the recovery path to the main path, the method comprising exchanging information between said first and second nodes via the recovery path so as to provide routing information for the packet traffic at said second node.

According to another aspect of the invention, there is provided a method of controlling re-routing of packet traffic from a main path to a recovery path in a communications label switched packet network, the method comprising; signalling over the recovery path control information whereby each said packet traversing the path is provided with a label stack so configured that, on return of the packet from the recovery path to the main path, the packet has at the head of its label stack a recognisable label for further routing of the packet.

According to a further aspect of the invention, there is provided a method of fault recovery in a communications label switched packet network constituted by a plurality of nodes interconnected by links and in which each packet is provided with a label stack from which network nodes traversed by that packet determine routing information for that packet, the method comprising; determining a set of traffic paths for the transport of packets, determining a set of recovery paths for re-routing traffic in the event of a fault on a said traffic path, each said recovery path linking respective first and second nodes on a corresponding traffic path, responsive to a fault between first and second nodes on a said traffic path, re-routing traffic between those first and second nodes via the corresponding recovery path, sending a first message from the first node to the second node via the recovery path, in reply to said first message sending a response message from the second node to the first node via the recovery path, said response message containing control information, and, at the first node, configuring the label stack of each packet traversing the recovery path such that, on arrival of the packet at the second node via the recovery path, the packet has at the head of its label stack a label recognisable by the second node for further routing of the packet.

According to another aspect of the invention, there is provided a packet communications network comprising a plurality of nodes interconnected by communications links, and in which network tunnels are defined for the transport of high quality of service traffic, the network comprising; means for providing each packet with a label stack containing routing information for a series of network nodes traversed by the packet; means for determining and provisioning a set of primary traffic paths within said tunnels for traffic carried over the network; means for determining a set of recovery traffic paths within said tunnels and for pre-positioning those recovery paths; and means for signalling over a said recovery path control information whereby each said packet traversing that recovery path is provided with a label stack so configured that, on return of the packet from the recovery path to a said main path, the packet has at the head of its label stack a recognisable label for further routing of the packet.

Advantageously, the fault recovery method may be embodied as software in machine readable form on a storage medium.

Preferably, primary traffic paths and recovery traffic paths are defined as label switched paths.

The fault condition may be detected by a messaging system in which each node transmits keep alive messages over links to its neighbours, and wherein the fault condition is detected from the loss of a predetermined number of successive messages over a link. The permitted number of lost messages indicative of a failure may be larger for selected essential links.

In a preferred embodiment, the detection of a fault is signalled to the network by the node detecting the loss of keep alive messages. This may be performed as a subroutine call.

### BRIEF DESCRIPTION OF THE DRAWINGS

An embodiment of the invention will now be described with reference to the accompanying drawings in which;

FIG. 1 is a schematic diagram of a label switched packet communications network;

FIG. 2 is a schematic diagram of a router;

FIG. 3 is schematic flow diagram illustrating a process of providing primary and recovery traffic paths in the network of FIG. 1;

FIG. 4 illustrates a method of signalling over a recovery path to control packet routing in the network of FIG. 1; and

FIG. 4a is a table detailing adjacencies associated with the signalling method of FIG. 4.

### DESCRIPTION OF PREFERRED EMBODIMENTS

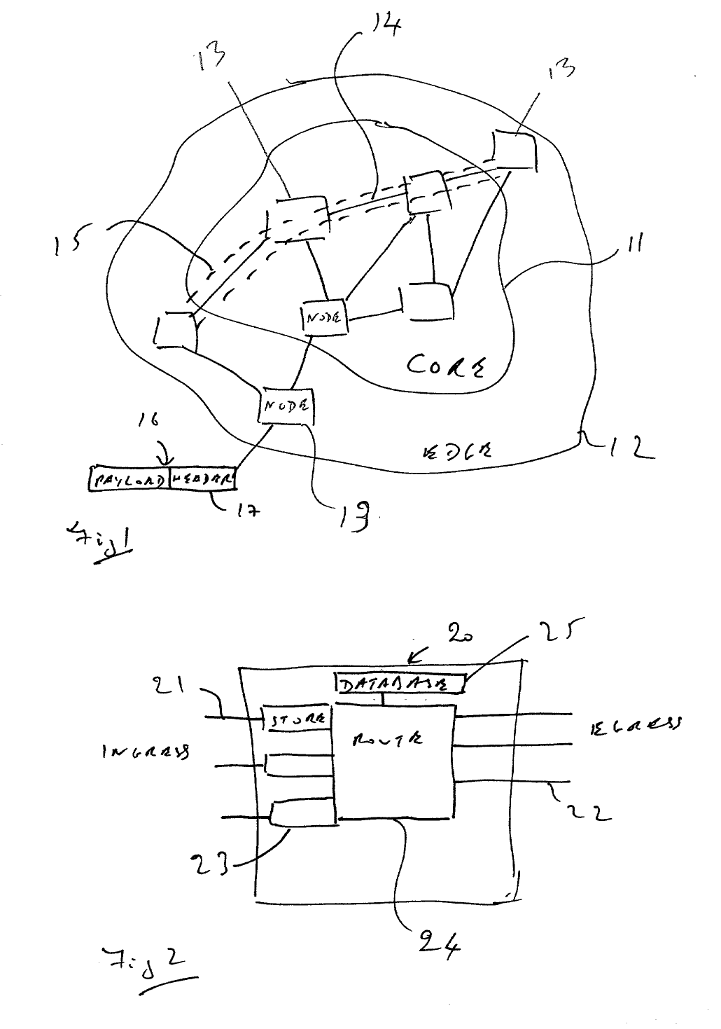

Referring first to FIG. 1, this shows in highly schematic form the construction of an exemplary packet communications network comprising a core network 11 and a access or edge network 12. The network arrangement is constituted by a plurality of nodes or routers 13 interconnected by communications links 14, so as to provide a full mesh connectivity. Typically the core network of FIG. 1 will transport traffic in the optical domain and the links 14 will comprise optical fibre paths. Routing decisions are made by the edge routers so that, when a packet is despatched into the core network, a route has already been defined.

Within the network of FIG. 1, tunnels 15 are defined for the transport of high quality of service (QoS) priority traffic. A set of tunnels may for example define a virtual private/public network. It will also be appreciated that a number of virtual private/public networks may be defined over the network of FIG. 1.

For clarity, only the top level tunnels are depicted in FIG. 1, but it will be understood that nested arrangements of tunnels within tunnels may be defined for communications purposes. Packets 16 containing payloads 17, e.g. high QoS traffic, are provided at the network edge with a header 18 containing a label stack indicative of the sequence of tunnels via which the packet is to be routed via the optical core in order to reach its destination.

FIG. 2 shows in highly schematic form the construction of a router for use in the network of FIG. 1. The router 20, has a number of ingress ports 21 and egress ports 22. For clarity, only three ingress ports and three egress ports are depicted. The ingress ports 21 are provided with buffer stores 23 in which arriving packets are queued to await routing decision by the routing circuitry 24. Those queues may have different priorities so that high quality of service traffic may be given priority over less critical, e.g. best efforts, traffic. The routing circuitry 24 accesses a routing table or database 25 which stores topological information in order to route each queued packet to the appropriate egress port of the router. It will be understood that some of the ingress and egress ports will carry traffic that is being transported through pre-defined tunnels.

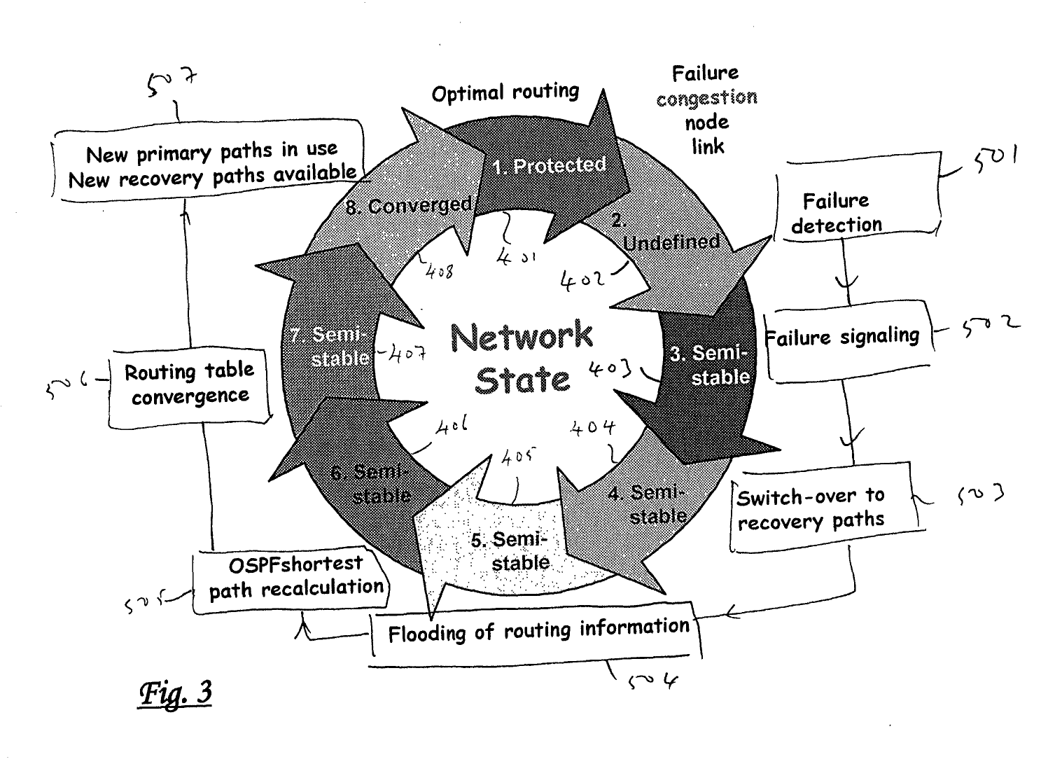

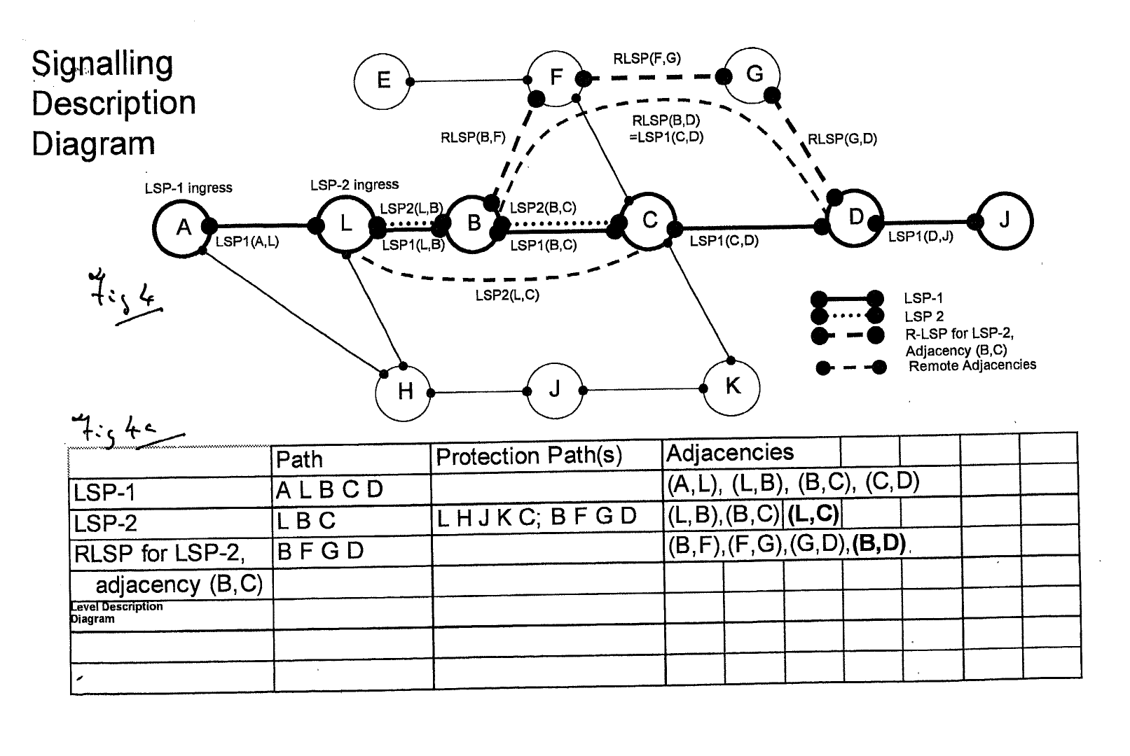

Referring now to FIG. 3, this is a flow chart illustrating an exemplary cycle of network states and corresponding process steps that provide detection and recovery from a failure condition in the network of FIG. 1. In the normal (protected) state 401 of operation of the network of FIG. 1, traffic is flowing on paths that have been established by the routing protocol, or on constraint based routed paths set up by an MPLS signalling protocol. If a failure occurs within the network, the traffic is switched over to pre-established recovery paths thus minimising disruption of delay-critical traffic. The information on the failure is flooded to all nodes in the network. Receiving this information, the current routing table, including LSPs for traffic engineering (TE) and recovery purposes, is temporarily frozen. The frozen routing table of pre-established recovery paths is used while the network converges in the background defining new LSPs for traffic engineering and recovery purposes. Once the network has converged, i.e. new consistent routing tables of primary paths and recovery paths exist for all nodes, the network then switches over to new routing tables in a synchronized fashion. The traffic then flows on the new primary paths, and the new recovery paths are pre-established so as to protect against a further failure.

To detect failures within the network of FIG. 1, we have developed a Fast LIveness Protocol (FLIP), that is designed to work with hardware support in the router forwarding (fast) path, has been developed. In this protocol, KeepAlive messages are sent every few milliseconds, and the failure to detect e.g. three successive messages is taken as an indication of a fault.

The protocol is able to detect a link failure as fast as technologies based on lower layers, typically within a few tens of milliseconds. When L3 is able to detect link failures so rapidly, interoperation with the lower layers becomes an issue: The L3 fault repair mechanism could inappropriately react before the lower layer repair mechanisms are able to complete their repairs unless the interaction has been correctly designed into the network.

The Full Protection Cycle illustrated in FIG. 3 consists of a number of process steps and network states which seek to restore the network to a fully operational state with protection against changes and failures as soon as possible after a fault or change has been detected, whilst maintaining traffic flow to the greatest extent possible during the restoration process. These states and process steps are summarised in Table 1 below.

TABLE 1

| State | Process Action Steps |
|---|---|
| 1 | Network in protected state |
| | Traffic flows on primary paths with recovery paths pre-positioned |
| | but not in use |
| 2 | a. Link/Node failure or a network change occurs |
| | b. Failure or change is detected |
| 3 | Signaling indicating the event arrives at an entity which can |
| | perform the switch-over |
| 4 | a. The switch-over of traffic from the primary to the recovery paths |
| | occurs |
| | b. The network enters a semi-stable state |
| 5-7 | Dynamic routing protocols converge after failure or change |
| | New primary paths are established (through dynamic protocols) |
| | New recovery paths are established |
| 8 | Traffic switches to the new primary paths |

Each of these states and the associated remedial process steps will be discussed individually below.

Network in Protected State

The protected state, i.e. the normal operating state, 401 of the network is defined by two criteria. Routing is in a converged state, traffic is carried on primary paths, and the recovery paths are pre-established according to a protection plan. The recovery paths are established as MPLS tunnels circumventing the potential failure points in the network.

A recovery path comprises a pre-calculated and pre-established MPLS LSP (Label Switched Path), which an IP router calculates from the information in the routing database. The LSP will be used under a fault condition as an MPLS tunnel to convey traffic around the failure. To calculate the recovery LSP, the failure to be protected against is introduced into the database; then a normal SPF (shortest path first) calculation is run. The resulting shortest path is selected as the recovery path. This procedure is repeated for each next-hop and ‘next-next-hop’. The set of ‘next-hop’ routers for a router is the set of routers, which are identified as the next-hop for all OSPF routes and TE LSPs leaving the router in question. The ‘next-next-hop’ set for a router is defined as the union of the next-hop sets of the routers in the next hop set of the router setting up the recovery paths but restricted to only routes and paths that passed through the router setting up the recovery paths.

Link/Node Failure Occurs

An IP routed network can be described as a set of links and nodes. Failures in this kind of network can thus affect either nodes or links.

Any number of problems can cause failures, for example anything from failure of a physical link through to code executing erroneously.

In the exemplary network of FIG. 1 there may thus be failures that originate either in a node or a link. A total L3 link failure may occur when a link is physically broken (the back-hoe or excavator case), a connector is pulled out, or some equipment supporting the link is broken. Such a failure is fairly easy to detect and diagnose.

Some conditions, for example an adverse EMC environment near an electrical link, may create a high bit error rate, which might make a link behave as if it was broken at one instant and working the next. The same behaviour might be the cause of transient congestion.

To differentiate between these types of failure, we have adopted a flexible strategy that takes account of hysteresis and indispensability:

Hysteresis The criteria for declaring a failure might be significantly less aggressive than those for declaring the link operative again, e.g. the link is considered non-operable if three consecutive FLIP messages are lost, but it will not be put back into operation again until a much larger number of messages have been successfully received consecutively.

Indispensability: A link that is the only connectivity to a particular location might be kept in operation by relaxing the failure detection criteria, e.g. by allowing more than three consecutive lost messages, even though failures would be repeatedly reported with the standard criteria.

A total node failure occurs when a node, for example, loses power. Differentiating between total node failure and link failure is not trivial and may require correlation of multiple apparent link failures detected by several nodes. To resolve this issue rapidly, we treat every failure as a node failure, i.e. when we have an indication of a problem we immediately take action as if the entire node had failed. The subsequent determination of new primary and reserve paths is performed on this basis.

Detecting the Failure

At step 501, the failure is detected by the loss of successive FLIP messages, and the network enters a undefined state 402. While the network is in this state 402, traffic continues to be carried temporarily on the functional existing primary paths.

In an IP routed network there are different kinds of failures—in general link and node failure. As discussed above, there may be many reasons for the failure, anything from a physical link breaking to code executing erroneously.

Our arrangement reacts to those failures that must be remedied by the IP routing protocol or the combination of the IP routing protocol and MPLS protocols. Anything that might be repaired by lower layers, e.g. traditional protection switching, is left to be handled by the lower layers.

As discussed above, a Fast Liveness Protocol (FLIP) that is designed to work with hardware support has been developed. This protocol is able to detect a link failure as fast as technologies based on lower layers, viz. within a few tens of milliseconds. When L3 is able to detect link failures at that speed interoperation with the lower layers becomes an issue, and has to be designed into the network.

Signaling the Failure to an Entity that can Switch-Over to Recovery Paths

Following failure detection (step 501), the network enters the first (403) of a sequence of semi-table states, and the detection of the failure is signalled at step 502. In our arrangement, recovery can be initiated directly by the node (router) which detects the failure. The ‘signalling’ (step 502) in this case is advantageously a simple sub-routine call or possibly even supported directly in the hardware (HW).

Switch-Over of Traffic from the Primary to the Recovery Paths

At step 503, the network enters a second semi-stable state 404 and the traffic affected by the fault is switched from the current primary path or paths to the appropriate pre-established recovery path or paths. The action to switch over the traffic from the primary path to the pre-established recovery path is in a router simply a case of removing or blocking the primary path in the forwarding tables so as to enable the recovery path. The switched traffic is thus routed around the fault via the appropriate recovery path. .

Routing Information Flooding

The network now enters its third semi-stable state (405) and routing information is flooded around the network (step 504).

The characteristic of the third semi-stable state 405 of the network is that the traffic affected by the failure is now flowing on a pre-established recovery path, while the rest of the traffic flows on those primary paths unaffected by the fault and defined by the routing protocols or traffic engineering before the failure occurred. This provides protection for that traffic while the network calculates new sets of primary and recovery paths.

When a router detects a change in the network topology, e.g. a link failure, node failure or an addition to the network, this information is communicated to its L3 peers within the routing domain. In link state routing protocols, such as OSPF and Integrated IS-IS, the information is typically carried in link state advertisements (LSAs) that are flooded’ through the network (step 504). The information is used to create within the router a link state database (LSDB) which models the topology of the network in the routing domain. The flooding mechanism ensures that every node in the network is reached and that the same information is not sent over the same interface more than once.

LSA's might be sent in a situation where the network topology is changing and they are processed in software. For this reason the time from the instant at which the first LSA resulting from a topology change is sent out until it reaches the last node might be in the order of a few seconds. However, this time delay does not pose a significant disadvantage as the network traffic is being maintained on the recovery paths during this time period.

Shortest Path Calculation

The network now enters its fourth semi stable state 406 during which new primary and reserve paths are calculated (step 505) using a shortest path algorithm. This calculation takes account of the network failure and generates new paths to route traffic around the identified fault.

When a node receives new topology information it updates its LSDB (link state database) and starts the process of recalculating the forwarding table (step 505). To reduce the computational load, a router may choose to postpone recalculation of the forwarding table until it receives a specified number of updates (typically more than one), or if no more updates are received after a specified timeout. After the LSAs (link state advertisements) resulting from a change are fully flooded, the LSDB is the same at every node in the network, but the resulting forwarding table is unique to the node.

While the network is in the semi-stable states 404 to 407, there will be competition for resources on the links carrying the diverted protected traffic. There are a number of approaches to manage this situation:

The simplest approach is to do nothing at all, i.e. non-intervention. If a link becomes congested, packets will be dropped without considering whether they are part of the diverted or non-diverted traffic. This method is conceivable in a network where traffic is not prioritized while the network is in a protected state. The strength of this approach is that it is simple and that there is a high probability that it will work effectively if the time during which the network remains in the semi-stable state is short. The weakness is that there is no control of which traffic is dropped and that the amounts of traffic that are present could be high.

Alternatively a prioritizing mechanism, such as IETF Differentiated Services markings, can be used to decide how the packets should be treated by the queuing mechanisms and which packets should be dropped. We prefer to achieve this via a Multiprotocol Label Switching (MPLS) mechanism.

MPLS provides various different mappings between LSPs (label switched paths) and the DiffServ per hop behaviour (PHB) which selects the prioritisation given to the packets. The principal mappings are summarised below.

Label Switched Paths (LSPs) for which the three bit EXP field of the MPLS Shim Header conveys to the Label Switched Router (LSR) the PHB to be applied to the packet (covering both information about the packet's scheduling treatment and its drop precedence). The eight possible values are valid within a DiffServ domain. In the MPLS standard this type of LSP is called EXP-Inferred-PSC LSP (E-LSP).

Label Switched Paths (LSPs) for which the packet scheduling treatment is inferred by the LSR exclusively from the packet's label value while the packet's drop precedence is conveyed in the EXP field of the MPLS Header or in the encapsulating link layer specific selective drop mechanism (ATM, Frame Relay, 802.1). In the MPLS standard this type of LSP is called Label-Only-Inferred-PSC LSP (L-LSP).

We have found that the use of E-LSPs is the most straightforward solution to the problem of deciding how the packets should be treated. The PHB in an EXP field of an LSP that is to be sent on a recovery path tunnel is copied to the EXP field of the tunnel label. For traffic forwarded on the L3 header the information in the DS byte is mapped to the EXP field of the tunnel.

The strengths of the DiffServ approach are that:

it uses a mechanism that is likely to be present in the system for other reasons,

traffic forwarded on the basis of the IP header and traffic forwarded through MPLS LSPs will be equally protected, and

the amount of traffic that is potentially protected is high.

In some circumstances a large number of LSPs will be needed, especially for the L-LSP scenario.

A third way of treating the competition for resources when a link is used for protection is to explicitly request resources when the recovery paths are set up either when the recovery path is pre-positioned or when the traffic is diverted along it. In this case the traffic that was previously using the link that will be used for protection of prioritised traffic, has to be dropped when the network enters the semi-stable state.

The information flooding mechanism used in OSPF (open shortest path first) and Integrated IS-IS does not involve signalling of completion and timeouts used to suppress multiple recalculations. This, together with, the considerable complexity of the forwarding calculation, may cause the point in time when the nodes in the network start using the new forwarding table may vary significantly between the nodes.

From the point in time when the failure occurs, until all the nodes have started to use their new routing tables, there might be a temporary failure to deliver packets to the correct destination. Traffic intended for a next hop on the other side of a broken link or for a next hop that is broken would get lost. The information in the different generations routing tables might be inconsistent and cause forwarding in loops. To guard against such a scenario, the TTL (time to live) incorporated in the IP packet header causes the packet to be dropped after a pre-configured number of hops.

Once the routing databases have been updated with new information, the routing update process is irreversible: The path recalculation processes (step 505) will start and a new forwarding table is created for each node. When this has been completed, the network enters its next semi-stable state 407.

Routing Table Convergence

While the network is in semi-stable state 407, new routing tables are created at step 506 ‘in the background’. These new routing tables are not be put into operation independently, but are introduced in a coordinated way across the routing domain.

If MPLS traffic is used in the network for other purposes than protection, the LSPs also have to be established before the new forwarding tables can be put into operation. The LSPs could be established by means of LDP or CR-LDP/RSVP-TE.

After the new primary paths have been established, new recovery paths are then established. The reason that we establish new recovery paths is that, as for the primary paths, the original paths might have become non-optimal or even non-functional, as a result of the changes in the network. For example. if the new routing protocol will potentially route traffic through node A, that formerly was routed through node B, node A has to establish recovery paths for this traffic and node B has to remove the old ones.

A recovery path is established as an explicitly routed label switched path (ER-LSP). The path is set up in such a way that it avoids the potential failure it is set up to overcome. Once the LSP is set up it will be used as a tunnel; information sent in to the tunnel is delivered unchanged to the other end of the tunnel.

If only traffic forwarded on the L3 header information is present, the tunnel could be used as it is. From the point of view of the routers (LSRs) at both ends of the tunnel, it will be a simple LER functionality. A tunnel-label is added to the packet (push) at the ingress LSR and removed at the egress (pop).

If the traffic to be forwarded in the tunnel is labelled or if it is a mix of labelled and un-labelled traffic, the labels to be used in the label stack immediately below the tunnel label have to be allocated and distributed. The procedure to do this is simple and straightforward. First a Hello Message is sent through the tunnel. If the tunnel bridges several hops before it reaches the far end of the tunnel, a Targeted Hello Message is used. The LSR at the far end of the tunnel will respond with a x message and establish an LDP adjacency between the two nodes at each end of the tunnels.

Once the adjacency is established, KeepAlive messages are sent through the tunnel to keep the adjacency alive. The next step is that the label switched router (LSR) at the originating end of the tunnel sends Label Requests to the LSR at the terminating end of the tunnel. One label for each LSP that needs protection will be requested.

Whether the traffic will be switched over to the new primary paths (steps 507) before or after the establishment of the recovery paths is network/solution dependent. If the traffic is switched over before the recovery paths are established this will create a situation where the network is unprotected. If the traffic is switched over after the recovery paths has been established the duration for which the traffic stays on the recovery paths might cause congestion problems.

With the network in its fifth semi-stable state (407), routing table convergence takes place (step 506).

In an IP routed network, distributed calculations are performed in all nodes independently to calculate the connectivity in the routing domain and the interfaces entering/leaving the domain. Both the common intra-domain routing protocols used in IP networks (OSPF and Integrated IS-IS) are link state protocols which build a model of the network topology through exchange of connectivity information with their neighbours. Given that routing protocol implementations are correct (i.e. according to their specifications) all nodes will converge on the same view of the network topology after a number of exchanges. Based on this converged view of the topology, a routing table is produced by each node in the network to control the forwarding of packets through that node, taking into consideration this particular node's position in the network. Consequently, the routing table, before and after the failure of a node or link, could be quite different depending on how route aggregation is affected.

The behaviour of the link state protocol during this convergence process (step 506) can thus be summarised in the four steps which are outlined below:

Failure occurrence

Failure detection

Topology flooding

Forwarding table recalculation

Traffic Switched Over to the New Primary Paths

The network now enters a converged state (state 408) in which the traffic is switched to the new primary paths (step 507) and the new recovery paths are made available.

In a traditional routed IP network, the forwarding tables will be used as soon as they are available in each single node. However, we prefer to employ a synchronized paradigm for the deployment of the new changes to a forwarding table. Three different methods of synchronization may be considered:

Use of timers to defer the deployment of the new routing tables until a pre-defined time after the first LSA indicating the failure is sent

Use of a diffusion mechanism that calculates when the network is loop free.

Synchronization master, one router is designated master and awaits reports from all other nodes before it triggers the use of the new routing tables.

Network Returns to Protected State

When the traffic has been switched to the new primary paths, the network returns to its protected state (401) and remains in that state until a new fault is detected.

Referring now to FIG. 4, this illustrates a method of signalling over the recovery path so as to ensure that packets traversing that recovery path each have at the top of their label stack a label that is recognisable by a node on the main path when that packet is returned to the main path. As shown in the schematic diagram of FIG. 4, which represents a portion of the network of FIG. 1 two label switched paths are defined as sequences of nodes, A, L, B, C, D (LSP-1), and L, B, C (LSP-2). To protect against faults in the path LSP-2, two protection or recovery paths are defined. These are L, H, J, K, C and B, F, G, D. adjacencies for these paths are illustrated in FIG. 4a.

In the event of a fault affecting the node C, traffic is switched on to the recovery path B, F, G, D at the node B. This node may be referred to as the protection switching node for this recovery path. The node D at which the recovery path returns to the main path may be referred to as the protection return node.

A remote adjacency is set up over the recovery path between the protection switching node B and the protection return node D via the exchange of information between these nodes over the recovery path. This in turn enables adjustment of the label stack of a packet dispatched on the main path, e.g. by “popping” the label for node C, such that on return to the main path at node D the packet has at the head of its stack a label recognised by node D for further routing of that packet.

The recovery mechanism has been described above with particular reference to MPLS networks. It will however be appreciated that the technique is in no way limited to use with such networks but is of more general application.

It will further be understood that the above description of a preferred embodiment is given by way of example only and that various modifications may be made by those skilled in the art without departing from the spirit and scope of the invention.

1. A method of controlling re-routing of packet traffic from a main path to a recovery path in a label switched packet communications network in which each packet is provided with a label stack containing routing information for a series of network nodes traversed by the packet, the method comprising; signalling over the recovery path control information whereby the label stack of each packet traversing the recovery path is so configured that, on return of the packet from the recovery path to the main path, the packet has at the head of its label stack a recognisable label for further routing of the packet.

2. A method as claimed in claim 1, wherein said primary traffic paths and recovery traffic paths are defined as tunnels.

3. A method as claimed in claim 2, wherein each label in a said label stack identifies a tunnel via which a packet provided with the label stack is to be routed.

4. A method of controlling re-routing of packet traffic from a main path to a recovery path in a communications label switched packet network, the method comprising; signalling over the recovery path control information whereby each said packet traversing the path is provided with a label stack so configured that, on return of the packet from the recovery path to the main path, the packet has at the head of its label stack a recognisable label for further routing of the packet.

5. A method of controlling re-routing of an information packet via a recovery path a first protection switching node and a second protection return node disposed on a main traffic path in a communications label switched packet network in which each packet is provided with a label stack containing routing information for a series of network nodes traversed by the packet, the method comprising; sending a first message from the first node to the second node via the recovery path, in reply to said first message sending a response message from the second node to the first node via the recovery path, said response message containing control information, and, at the first node, configuring the label stack of the packet such that, on arrival of the packet at the second node via the recovery path, the packet has at the head of its label stack a label recognisable by the second node for further routing of the packet.

6. A method of controlling re-routing of packet traffic in a label switched packet communications network at a first node from a main path to a recovery path and at a second node from the recovery path to the main path, the method comprising exchanging information between said first and second nodes via the recovery path so as to provide routing information for the packet traffic at said second node.

7. A method of fault recovery in a communications label switched packet network constituted by a plurality of nodes interconnected by links and in which each packet is provided with a label stack from which network nodes traversed by that packet determine routing information for that packet, the method comprising; determining a set of traffic paths for the transport of packets, determining a set of recovery paths for re-routing traffic in the event of a fault on a said traffic path, each said recovery path linking respective first and second nodes on a corresponding traffic path, responsive to a fault between first and second nodes on a said traffic path, re-routing traffic between those first and second nodes via the corresponding recovery path, sending a first message from the first node to the second node via the recovery path, in reply to said first message sending a response message from the second node to the first node via the recovery path, said response message containing control information, and, at the first node, configuring the label stack of each packet traversing the recovery path such that, on arrival of the packet at the second node via the recovery path, the packet has at the head of its label stack a label recognisable by the second node for further routing of the packet.

8. A method of fault recovery in a packet communications network comprising a plurality of nodes interconnected by communications links, in which each packet is provided with a label stack containing routing information for a series of network nodes traversed by the packet, the method comprising; determining and provisioning a set of primary traffic paths for traffic carried over the network; determining a set of recovery traffic paths and pre-positioning those recovery paths; and in the event of a network fault affecting a said primary path, signalling an indication of the fault condition to each said node so as to re-route traffic from that primary path to a said recovery paths, and signalling over the recovery path control information whereby the label stack of each packet traversing a said recovery path is so configured that, on return of the packet from the recovery path to the main path, the packet has at the head of its label stack a recognisable label for further routing of the packet.

9. A method of fault recovery in a packet communication network comprising a plurality of nodes interconnected by communication links and in which tunnels are defined for the transport of high quality of service traffic, the method comprising;
determining and provisioning a first set of primary traffic paths within said tunnels;
determining a first set of recovery traffic paths within said tunnels, and pre-positioning those recovery paths;
responsive to a fault condition, signalling to the network nodes an indication of said fault so as to provision a said recovery path thereby re-routing traffic from a main path on to that recovery path;;
signalling over the recovery path control information whereby the label stack of each packet traversing a said recovery path is so configured that, on return of the packet from the recovery path to the main path, the packet has at the head of its label stack a recognisable label for further routing of the packet;
determining a further set of primary traffic paths, and a further set of recovery paths;
provisioning said further set of primary traffic paths and switching traffic to said further primary paths; and
pre-positioning said further set of recovery traffic paths.

10. A method as claimed in claim 9, wherein said primary traffic paths and recovery traffic paths are defined as label switched paths.

11. A method as claimed in claim 10, wherein each said node transmits keep alive messages over links to its neighbours, and wherein said fault condition is detected from the loss of a predetermined number of successive messages over a said link.

12. A method as claimed in claim 11, wherein said number of lost messages indicative of a failure is larger for selected essential links.

13. A method as claimed in claim 12, wherein said fault detection is signalled to the network by the node detecting the loss of keep alive messages.

14. A method as claimed in claim 13, wherein said signalling of the fault detection is performed by the node as a sub-routine call.

15. A method as claimed in claim 14, wherein each said node creates a link state database which models the topology of the network in the routing domain.

16. A method as claimed in claim 7, and embodied as software in machine readable form on a storage medium.

17. A packet communications network comprising a plurality of nodes interconnected by communications links, and in which network tunnels are defined for the transport of high quality of service traffic, the network comprising; means for providing each packet with a label stack containing routing information for a series of network nodes traversed by the packet; means for determining and provisioning a set of primary traffic paths within said tunnels for traffic carried over the network; means for determining a set of recovery traffic paths within said tunnels and for pre-positioning those recovery paths; and means for signalling over a said recovery path control information whereby each said packet traversing that recovery path is provided with a label stack so configured that, on return of the packet from the recovery path to a said main path, the packet has at the head of its label stack a recognisable label for further routing of the packet.

18. A packet communications network comprising a plurality of nodes interconnected by communications links, and in which network tunnels are defined for the transport of high quality of service traffic, the network comprising; means for determining and provisioning a set of primary traffic paths within said tunnels for traffic carried over the network; means for determining a set of recovery traffic paths within said tunnels and for pre-positioning those recovery paths; and in the event of a network fault affecting one or more of said primary paths, signalling an indication of the fault condition to each said node so as to provision said set of recovery traffic paths.

19. A communications packet network comprising a plurality of nodes interconnected by communication links and in which tunnels are defined for the transport of high quality of service traffic, the network having a first set of primary traffic paths within said tunnels; and a first set of pre-positioned recovery traffic paths within said tunnels for carrying traffic in the event of a fault affecting one or more said primary paths, wherein the network comprises;
fault detection means responsive to a fault condition for signalling to the network nodes an indication of said fault so as to provision said first set of recovery paths;
path calculation means for determining a further set of primary traffic paths and a further set of recovery paths;
path provisioning means for provisioning said further set of primary traffic paths and said further set of recovery traffic paths; and
path switching means for switching traffic to said further primary paths.

20. A network as claimed in claim 17, wherein each said node comprises a router.

21. A network as claimed in claim 18, wherein each said router has means for transmitting a sequence of keep alive messages over links to its neighbours, and wherein said fault condition is detected from the loss of a predetermined number of successive messages over a said link.

22. A network as claimed in claim 21, wherein said number of lost messages indicative of a failure is larger for selected essential links.

23. A network as claimed in claim 22, wherein said fault detection is signalled to the network by the router detecting the loss of keep alive messages.

24. A network as claimed in claim 23, wherein said fault detection signalling is performed by the router as a sub-routine call.

25. A network as claimed in claim 24, wherein each said router incorporates a link state database which models the topology of the network in the routing domain.

26. A network as claimed in claim 25 and comprising a multi-service protocol label switched (MPLS) network.

27. A method of controlling re-routing of an information packet via a recovery path between first and second nodes disposed on a main traffic path in a communications label switched packet network in which each packet is provided with a label stack containing routing information for a series of network nodes traversed by the packet, the method comprising; sharing information between said first and second nodes via the recovery path so as to configure the label stack of the packet such that, on arrival of the packet at the second node via the recovery path, the packet has at the head of its label stack a label recognisable by the second node for further routing of the packet.
